(19) United States
(12) Patent Application Publication
(10) Pub. No.: US 2026/0050604 A1
(43) Pub. Date: Feb. 19, 2026

(54) In-Memory Result Set Rebalancing For Distributed Graph Queries

(71) Applicant: Oracle International Corporation, Redwood Shores, CA (US)

(72) Inventors: Arnaud Delamare, Zurich (CH); Ayoub Berdai, Sale (MA); Vasileios Trigonakis, Zurich (CH); Anas Soukrat, Casablanca (MA); Calin Iorgulescu, Zurich (CH); Petr Koupy, Zurich (CH); Jinsu Lee, San Mateo, CA (US); Sungpack Hong, Palo Alto, CA (US)

(21) Appl. No.: 18/806,669

(22) Filed: Aug. 15, 2024

(51) Int. Cl. G06F 16/2458; G06F 11/34; G06F 16/2452; G06F 16/2455

(52) U.S. Cl. CPC G06F 16/2471; G06F 11/3409; G06F 16/24526; G06F 16/24552; G06F 16/24561

(57) ABSTRACT

Two modes of result set rebalancing are provided to cover the needs of distributed graph engines: unordered and ordered rebalancing. Unordered rebalancing allows moving any combination of chunks from one machine to another with the only goal being to reach a target balance. Ordered rebalancing maintains the order of a result set, dividing and rebuilding new chunks as they are moved between consecutive machines in the order of the result set to reach the target balance. The rebalancing solutions capitalize on the internal structure of result sets commonly present distributed graph processing systems.

### FIELD OF THE INVENTION

The present invention relates to in-memory distributed graph processing systems and, more specifically, to in-memory result set rebalancing for distributed graph processing systems.

### BACKGROUND

A graph database is a database that uses graph structures for semantic queries with nodes, edges, and properties to represent and store data. A graph relates data items in the store to a collection of nodes and edges, the edges representing the relationships between the nodes. The relationships allow data in the store to be linked together directly and, in many cases, retrieved with one operation. Graph databases hold the relationships between data as a priority. The underlying storage mechanism of graph databases can vary. Relationships are a first-class citizen in a graph database and can be labeled, directed, or given properties. Some implementations use a relational engine and store the graph data in a table.

Distributed in-memory graph queries enable processing very large graphs. To guarantee the completion of distributed queries on graph data, it is essential to control memory consumption during graph querying and pattern matching. A promising approach is through the use of asynchronous distributed traversals. These traversals not only ensure flow control to limit memory consumption but also facilitate high parallelism, thereby enhancing performance and scalability, as well as hiding communication latency.

Graph workloads, however, suffer often from high data skew, where certain high-degree vertices end up being the “sink” or source for important graph traversals. This problem is exacerbated in distributed systems, where, almost inevitably, the data skew translates to imbalanced result set for distributed graph queries. These graph queries-regardless of the query language, e.g., Property Graph Query Language (PGQL), Structured Query Language/Property Graph Query (SQL/PGQ), Cypher-produce tabular result sets, similar to those yielded by a SQL query. For instance, running the following graph query (using the PGQL language, for example) from the Transaction Processing Performance Council TPC-H benchmark, which lists the revenue volume done through local suppliers in Asia will result in a possibly imbalanced result set, if a match is identified, since all records may reside on the same machine as the REGION vertex with R_NAME= ‘ASIA’. The query, TPC-H Q5, is as follows:

```
SELECT
  n.N_NAME,
  SUM(l.L_EXTENDEDPRICE * (1 − l.L_DISCOUNT)) AS
  REVENUE
FROM tpc
MATCH
  (l :LINEITEM) - [:LINEITEM_ORDERS] −>(o :ORDERS),
  (l) - [:LINEITEM_SUPPLIER] −>(s :SUPPLIER),
  (o) - [: ORDER_CUSTOMER] −>(c :CUSTOMER),
  (s) - [:SUPPLIER_NATION] −>(n),
  (c) - [:CUSTOMER_NATION] −>(n :NATION),
  (n) - [:NATION_REGION] −>(r :REGION)
WHERE
  r.R_NAME = ‘ASIA’ # The REGION ‘ASIA’ is a single vertex!
  AND o.O_ORDERDATE >= DATE ‘1994-01-01’
  AND o.O_ORDERDATE < DATE ‘1995-01-01’
GROUP BY
  n.N_NAME
ORDER BY
  REVENUE DESC
```

The above query includes a SELECT statement, which indicates the data to be retrieved from one or more tables of a database or a graph. The FROM statement indicates the graph being searched. The MATCH statement begins a pattern-matching portion of the query, which defines the pattern to be matched to the graph. The WHERE statement begins a filter portion of the query, which sets forth conditions to be applied to the matching patters. The GROUP BY clause groups the result set into subsets. The ORDER BY clause sorts the result set by one or more columns in ascending or descending order (descending in this example).

The issue is prevalent in any distributed graph query engine that pushes computation to data. For instance, in distributed asynchronous traversals, only computation contexts are pushed, while the underlying data remains on its original machine. Following a successful pattern match, the corresponding record is materialized utilizing the pre-existing context to minimize communication overhead and, eventually, appended on the machine in which it was completed.

In addition to the inherent possible imbalances in query result sets, distributed graph engines might offer elasticity, i.e., the ability to dynamically add and remove machines from the cluster as needed during runtime, which could also result in an imbalance of frames. If a new machine joins, it will initially not possess any part of the pre-existing result sets, unlike the existing cluster members. Therefore, rebalancing is necessary to enable the new machine to participate in holding the result set data and avoid under-utilizing its resources. Whereas when removing a machine from the cluster, it is necessary to use a rebalancing operation to evacuate the partitions it is holding and avoid any data losses, i.e. assign a weight 0 to the machine to be removed, where weights are decimal values that reflect the amount of data each machine should hold at the end of the rebalancing operation.

The graph pattern matching results sets are often used in post-processing operators. For instance, in the example query above, once the pattern matching completes (the MATCH operator), the result set is used in the traditional GROUP BY and ORDER BY operators. Therefore, the result-set rebalancing operations must maintain the performance characteristics of the original result set, meaning that virtually rebalancing rows (e.g., by remapping row id X to row id Y) is not a performance viable solution.

Finally, rebalancing must provide different guarantees depending on when/where it is invoked, i.e.:
Rebalancing after MATCH and before GROUP BY can reshuffle rows as needed, given that the result set is inaccessible to the user up to that point.
However, rebalancing after the user has started accessing the result set means that rebalancing must maintain the ordering of rows; otherwise, the user would see inconsistent results. The same is true for results sets that are the result of a final ORDER BY.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1A illustrates an intermediate result set for an example graph query in accordance with an embodiment.

FIG. 1B illustrates a final result set of an example graph query in accordance with an embodiment.

FIG. 2 depicts result set chunk order and distribution among machines in accordance with an embodiment.

FIG. 3 depicts an example of unordered rebalancing of a result set in accordance with an embodiment.

FIG. 4 depicts an example of ordered rebalancing of a result set in accordance with an embodiment.

FIG. 5 is a flowchart illustrating operation of a distributed asynchronous graph engine for result set rebalancing in accordance with an embodiment.

FIG. 6 is a flowchart illustrating operation of a distributed asynchronous graph engine for unordered result set rebalancing in accordance with an embodiment.

FIG. 7 is a flowchart illustrating operation of a distributed asynchronous graph engine for order-preserving result set rebalancing in accordance with an embodiment.

FIG. 8 is a block diagram that illustrates a computer system upon which aspects of the illustrative embodiments may be implemented.

FIG. 9 is a block diagram of a basic software system that may be employed for controlling the operation of a computer system in accordance with an illustrative embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Asynchronous distributed graph traversals enable graph queries with a high degree of parallelism and a precise control over memory consumption, thereby enabling the capability to process large datasets. Nevertheless, graph workloads often suffer from high data skew due to hot high-degree vertices (vertices with a large number of edges). The illustrative embodiments present an approach for efficiently rebalancing skewed graph query result sets with a focus on results for distributed asynchronous traversals. The approach uses actual materialized rebalancing to ensure no performance loss for result-set operations and enables both order-preserving and random-order rebalancing to support all possible graph queries.

A result set is a tabular data structure. In this disclosure, the terms result set and frame are used interchangeably. The tabular data structure holds an intermediate or final query result set. In accordance with the illustrative embodiment, the result set is segmented for better concurrency, and column-oriented for better value access, into fixed-sized segments called “chunks.” The illustrative embodiments provide two modes of result set (or frame) rebalancing to cover the complete needs of distributed graph engines: unordered and ordered rebalancing.

Unordered rebalancing allows moving any combination of chunks from one machine to another with the only goal being to reach a target balance. Generally, unordered rebalancing is preferable when the frame is not yet accessible by the user, especially for intermediate results of the distributed asynchronous graph traversals of graph queries. Unordered rebalancing is preferred over ordered rebalancing is such a use case, because it minimizes the number of chunks moving around in the cluster, avoids slicing, and is overall a more lightweight process.

Ordering is a strict requirement for result sets that have been accessible to the user to guarantee results consistency. Unordered rebalancing would destroy the order that the user would have already seen—i.e., would be qualified as a bug. Similarly, result sets that are the result of an ORDER BY query must naturally have their order preserved, even if the user has not accessed them yet. Ordered rebalancing maintains the order of a result set, dividing and rebuilding new chunks as they are moved between consecutive machines in the order of the result set to reach the target balance.

The illustrative embodiments enable a distributed graph engine to offer efficient parallel ordered and unordered rebalancing of graph query result sets, enabling better query performance, memory balance, and elasticity. Due to the materialized nature of rebalancing, operations executing on top of the rebalanced result sets benefit from the better balance and have no overheads (e.g., due to virtual renaming of chunk/row IDs). In addition, the illustrative embodiments support gradual rebalancing, perfectly suitable when the available memory is limited or when fully rebalancing the frame would take too long.

The illustrative embodiments capitalize on the internal structure of result sets/frames commonly present in distributed graph processing systems. The approach ensures fast data movements and generates minimal transfer plans to attain the desired row distributions. In the ordered mode, row sequencing is maintained without necessitating the invocation of an ordering algorithm, which depending on its implementation, might alter the distribution. Additionally, the approach facilitates the possibility to rebalance gradually. This not only reduces the execution time per rebalancing iteration, enhancing system availability for the user, but also accommodates limited available memory, as the transferred data is significantly smaller than its original magnitude would have been.

The described rebalancing operation is by design materializing ordered rebalance to maintain performance of operations on top results which often require direct indexing of frame rows. This materialized rebalancing is naturally more expensive than a virtualized rebalancing, where chunks are reindexed virtually to other machines. Depending on the requirements of the specific graph system, materialized rebalancing could bring more overhead than benefits; however, in most cases, the rebalancing approach of the illustrative embodiments will achieve performance benefits that outweigh the increased overhead.

Distributed in-Memory Graph Query Processing

A graph engine adopting the state-of-the-art distributed asynchronous traversals (but also most graph query and pattern matching engines) executes distributed graph queries through a sequence of two phases: asynchronous pattern matching, where the engine performs the identification of patterns within the graph data then it captures and project the necessary properties for the next stage in a tabular data structure similar to SQL, and bulk synchronous result modification, which may involve the application of aggregation (GROUP BY) and/or sorting (ORDER BY) operations on the intermediate result set. Engines without distributed asynchronous traversals also follow these two phases, but perform the graph pattern matching with different strategies, e.g., breadth-first search (BFS).

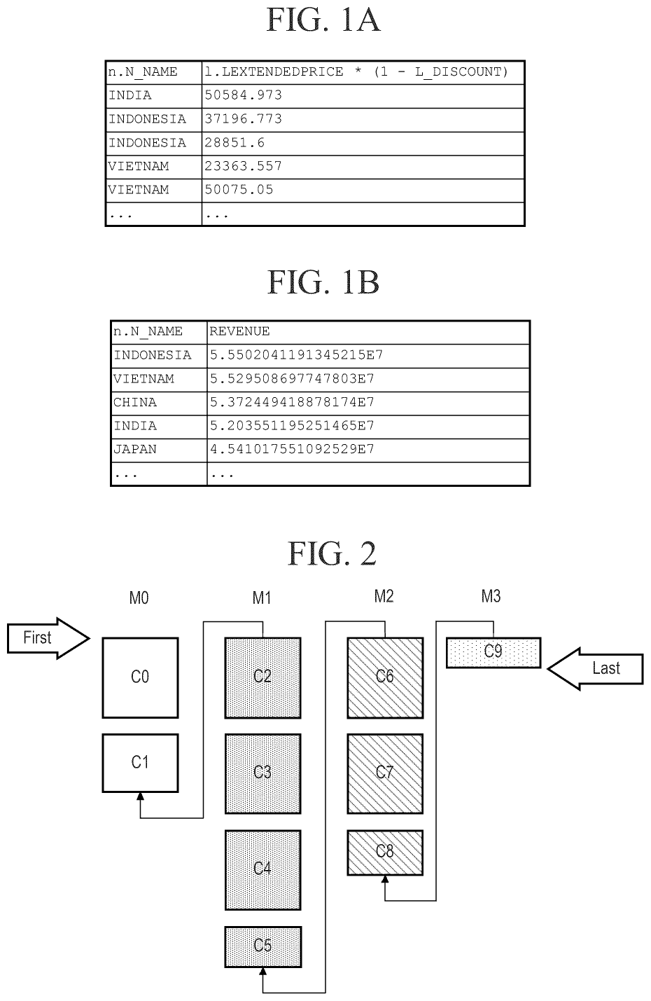

For example, to process the above query (Q5 of the TPC-H benchmark), the engine first identifies the pattern (1: LINEITEM)—[: LINEITEM ORDERS]->(o: ORDERS), (1)—[: LINEITEM SUPPLIER]-> (s: SUPPLIER), (o)—[: ORDER CUSTOMER]-> (c: CUSTOMER), (s)—[: SUPPLIER NATION]-> (n), (c)—[: CUSTOMER NATION]-> (n: NATION), (n)—[: NATION REGION]-> (r: REGION) within the graph where orders have been placed during the year 1994 (o.O_ORDERDATE >=DATE ‘1994-01-01’ AND o.O_ORDERDATE <DATE ‘1995 Jan. 1’) between Asian suppliers and customers (r.R_NAME= ‘ASIA’). Note that graph query result sets for all state-of-the-art graph query languages (e.g., PGQL, Cypher, GSQL, SQL/PGQ) return result sets in a tabular format, similar to the way SQL does for RDBMSs. FIG. 1A illustrates an intermediate result set for an example graph query in accordance with an embodiment.

Next, the engine performs aggregations and ordering to return the final result set of the query. FIG. 1B illustrates a final result set of an example graph query in accordance with an embodiment. The result set is a tabular data structure, resembling a Dataframe (e.g., as in Apache Spark or Python Pandas). In accordance with the embodiment, the frame holding the intermediate or final query result set is segmented for better concurrency, and column-oriented for better value access. The tabular data structure is designed to assist a distributed asynchronous graph engine hold the result of a query and run different operations. It should thus support both write/read-heavy usage. This is done through the following characteristics:
Chunked data: The dataframe is segmented into multiple equal size chunks which helps with (1) writing to the dataframe (Each thread writes to its own chunk, and only when the latter is full or it finishes executing does the thread acquire a lock to append its chunk to the dataframe), and (2) with all chunks having the same size, the workloads can be split evenly on the worker threads for faster processing.
Column-oriented: The dataframe is a columnar structure, which improves data access, decreases cache memory misses and avoids padding for alignment.
Memory storage: To handle dynamic data such as strings, each chunk within the dataframe has an assigned memory store that allocates memory in bulk to avoid memory fragmentation.

The fixed-sized segments are referred to as “chunks.” Each chunk contains multiple rows and data for multiple columns of the rows it contains. Chunks may also be used for assigning workloads to threads on the machines. For example, machine M1 may assign chunks C2, C3 to a first thread and assign chunks C4, C5 to a second thread.

In addition to the aforementioned characteristics, the dataframe may have two important aspects:
Packed: It is apparent that during the writing operations, a thread may append a non-full chunk to the dataframe, which can have two drawbacks: (1) more memory usage as the dataframe may hold more chunks than needed which are not fully using their allocated memory, and (2) unguaranteed thread balance. The dataframe runs a packing operation whenever the possibility emerges to minimize the number of chunks (and thus the memory consumption), leaving at most a single non-full chunk on each machine which can only be the last chunk of the local array of chunks.
Ordered (order for chunks and not for data): For the consistency of results, even when the query that generated the data did not specify an order, each chunk has an assigned order that depends on the machine ID on which it resides and the index of it within the local array of chunks. For example, the first row in a frame is the first row of the first chunk in the first machine holding a portion of the frame, and the last row in a frame is the last row of the last chunk in the last machine holding a portion of the frame. The order of machines in a cluster is deduced from their ID, such as a lower ID for previous machines, and a greater ID for subsequent machines.
   During rebalancing, the most expensive operation is the movement of data around the cluster to its final destination. Leveraging the internal design of the frame is important.

FIG. 2 depicts result set chunk order and distribution among machines in accordance with an embodiment. The result set or frame consists of chunks C0-C9, which are distributed over machines M0-M3. Note that the last chunk in each machine may be a non-full chunk, meaning the chunk contains fewer rows than the capacity for a full chunk. For example, C1, C5, C8, and C9 may be non-full chunks. As depicted in FIG. 2, in order to support distributed row ordering, consider that for a result set with N rows, the first row of the first machine M0 is row 0 (first row) in chunk C0. The first row in machine is M0 is the first row that the first chunk C0 holds in that machine. Similarly, the last N-1 row globally, is the last row of the last chunk C9 in the last machine M3.

### Unordered Rebalancing

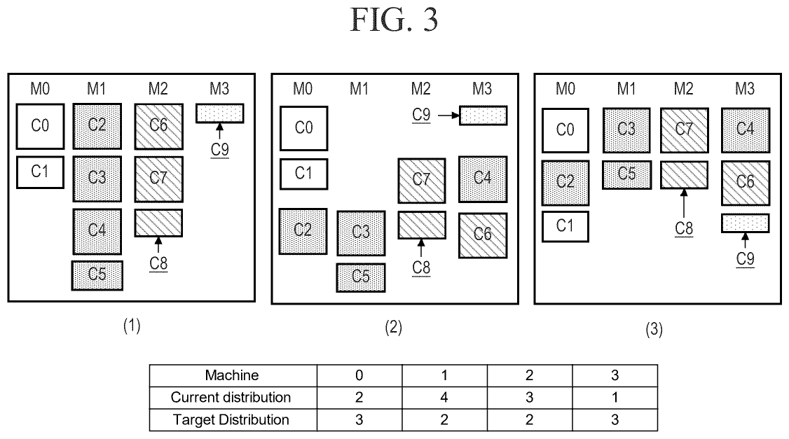

FIG. 3 depicts an example of unordered rebalancing of a result set in accordance with an embodiment. In step (1), machine M0 has two chunks C0, C1, machine M1 has four chunks C2-C5, machine M2 has three chunks C6-C8, and machine M3 has one chunk C9. Thus, the current distribution is (2, 4, 3, 1). In the depicted example, the target chunk distribution is (3, 2, 2, 3). In this example, the total number of chunks in the target chunk distribution is 10. An equal distribution of weights would be (0.25, 0.25, 0.25, 0.25), which would result in a target distribution of (3, 3, 2, 2). However, in the example, the target chunk distribution is based on a set of weights (0.3, 0.2, 0.2, 0.3) or (30%, 20%, 20%, 30%). These weights may be based on the resources assigned to the respective machines (e.g., CPUs, memory, storage, network bandwidth) or the capabilities of those machines. These weights may be used to ensure generic usage of the algorithm beyond rebalancing for memory, such as rebalancing for compute, data locality, cost for the tenants, etc. Use of machine weights is described in further detail below. Note that the approach involves a chunk-oriented rebalancing instead of row-based rebalancing, i.e., rebalancing on chunk and not row to align with how we transfers are performed (also chunk-based).

In step (1) machines M1 and M2 have a surplus of two and one chunks respectively. This excess will be directly sent to the machines with a deficit (i.e., machines M0 and M3) starting from the head of local chunks array. Moving from the front of the chunks array is preferred to minimize the need for row shifting during the “pack( )” operation, because the chunks will mostly be full unless the sending machine has a weight of 0 (indicating the machine will be removed from the cluster). Note that the example is described as sequential steps; however, in an embodiment, all transfers are performed simultaneously. In step (2) machine M1 sends chunk C2 to machine M0 and sends chunk C3 to machine M3. Similarly, machine M2 sends chunk C6 to machine M3. The received chunks are appended on the chunks arrays of the destination machines. Finally, in step (3), the packing operation is called to have at most a single non-full chunk on each machine residing at the tail of the chunks array. Packing enables operations on top of the frame to do fast direct indexing of rows by id, by simple dividing the row_id by:

$$chunk\_id = row\_id / chunk\_capacity$$

$$in - chunk\_id = row\_id \% chunk\_capacity$$

### Ordered Rebalancing

Ordering is a strict requirement for result sets that have been accessible to the user, e.g., by graph.runQuery( . . . ).print( ) to guarantee results consistency. Unordered rebalancing would destroy the order that the user would have already seen—i.e., would be qualified as a bug. Similarly, result sets that are the result of an ORDER BY query need to naturally have their order preserved, even if the user has not accessed them yet. To avoid data movement row by row and leverage the internal design of the frames (i.e., segmented and column-oriented nature), ordered rebalancing builds new chunks as needed directly in the messaging channels when the new chunk consists of parts from successive chunks, instead of sending them as parts. Thus, no more processing is needed from the receiving machine perspective.

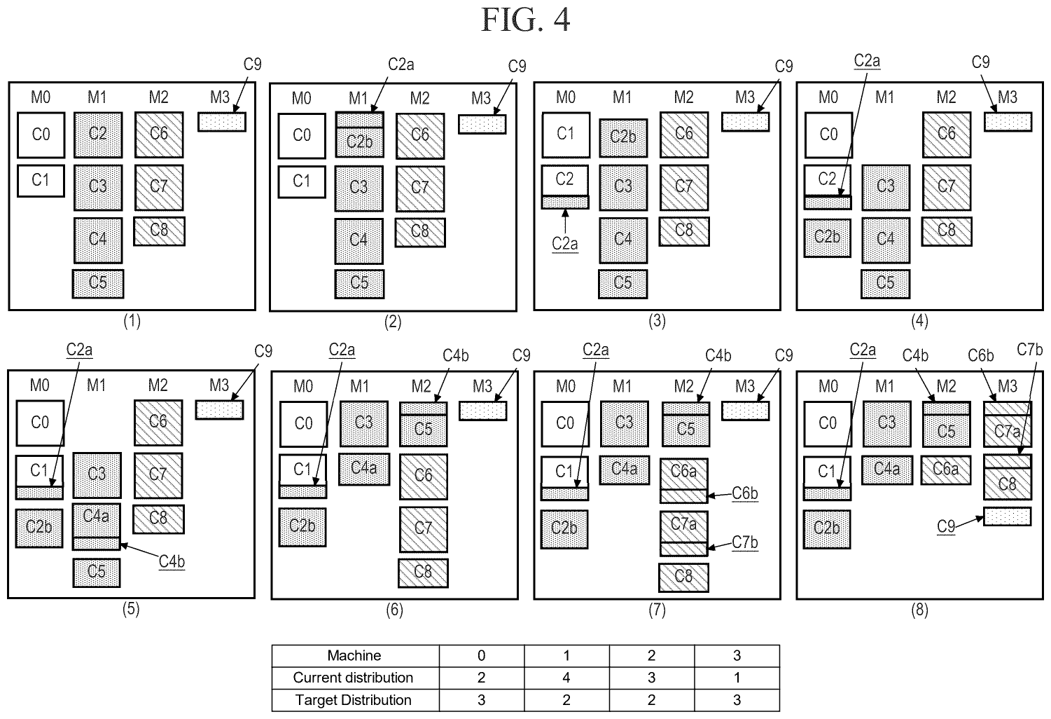

FIG. 4 depicts an example of ordered rebalancing of a result set in accordance with an embodiment. Similar to the example shown in FIG. 3, the current distribution is (2, 4, 3, 1), and the target chunk distribution is (3, 2, 2, 3). In step (1) of FIG. 4, machine M0 needs one more chunk, which is received from machine M1. This is done by first completing the non-full chunk C1 on machine M0, then the rest of the head chunk is sent so that the frame partition on machine M1 is packed. A frame is considered “packed” when every machine holds at most a single non-full chunk at the back of its chunks array. This is desired to improve granularity, since during frame operations, each thread processes selected chunks, evenly divided to distribute the workload. Similarly, the aim for packed structure is to also reduce memory overheads: when allocating a chunk, the same column sizes regardless of whether they are empty or completely full. As stated above, the example is described as sequential steps; however, in an embodiment, all transfers are performed simultaneously.

Thus, in step (2), machine M1 divides chunk C2 into two non-full chunks: C2a, which can be combined with chunk C1 to form a full chunk, and C2b. In step (3), machine M1 transfers chunk C2a to machine M0, which combines chunks C1 and C2a to form one full chunk. Then, in step (4), machine M1 transfers chunk C2b to machine M0, which is then the last non-full chunk on machine M0. At the end of step (4), machine M1 still has a surplus of one chunk, machine M2 has a surplus of one chunk, and machine M3 has a deficit of two chunks.

In step (5), machine M1 divides chunk C4 into two non-full chunks: C4a and C4b, which can be combined with chunk C5 to form a full chunk. In step (6), machine M1 combines chunk C4b and chunk C5 to form a full chunk and transfers that full chunk to machine M2. At the end of step (6), machine M2 has a surplus of two chunks, and machine M3 has a deficit of two chunks.

In step (7), machine M2 divides chunk C7 into two non-full chunks: C7a and C7b, which can be combined with chunk C8 to form a full chunk. In addition, machine M2 divides chunk C6 into two non-full chunks: C6a and C6b, which can be combined with chunk C7a to form a full chunk. In step (8), machine M2 combines chunks C7b and C8 to form a full chunk, transfers the full chunk to machine M3, combines chunks C6b and C7a to form a full chunk, and transfers that full chunk to machine M3. At the end of step (8), the target distribution is achieved.

Note that the issue of skewed distribution of data in the cluster is the result of the first stage (distributed asynchronous graph traversals) and may be reduced in the second stage thanks to the aggregation and ordering operations. However, such operations are not always present in a query, and thus there is a need for an appropriate solution.

### Procedural Overview

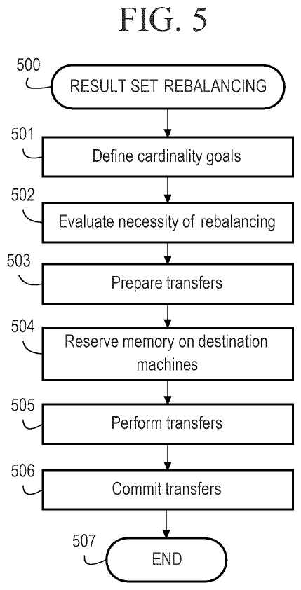

While both proposed rebalancing methods use different approaches to identify the data to be transferred and their respective destinations, they share most of their components/steps. FIG. 5 is a flowchart illustrating operation of a distributed asynchronous graph engine for result set rebalancing in accordance with an embodiment. Operation begins with result set rebalancing (block 500), and the engine defines cardinality goals (block 501). First, the engine must compute the goal chunk distribution (i.e., the number of rows each machine must hold by the end of rebalancing), which is dependent on provided machine weights in a best effort approach. As described above, the machine weights are an array of floating-point values or percentages with the same size as the number of machines in the cluster such as the corresponding value to each machine is the percentage of data size that the machine must hold by the end of rebalancing. This is adopted to introduce flexibility in the management of data distribution and can be essential to ensure the goal of rebalancing in many cases such as heterogenous clusters in which machines do not have the same memory capacities, etc.

The engine evaluates necessity of rebalancing (block 502). The engine compares the current cardinality distribution and the one to be achieved to decide if rebalancing is needed. Multiple skipping policies can be adopted at this stage to minimize the cost of the rebalancing operation and only perform rebalancing when necessary.

The engine prepares transfers (block 503). This constitutes the step at which the approaches diverge. The engine generates the transfers, which are a description of data movements that must be conducted by the system to achieve the target distribution. Each transfer specifies the source machine and the destination machine, the set of rows that must be transferred and, if needed, the order of the data sent.

The engine reserves memory on destination machines (block 504). Before performing the generated transfers, the engine makes sure that all destination machines have enough resources to hold the received data. At this stage, the exact memory needs may not be cheap to compute, and thus estimates are used instead.

The engine performs transfers (block 505). At this stage, the engine transfers the data from sender to destination machines simultaneously. This is an important aspect for a faster performance and can only be achieved by precalculated exact cardinalities. The data received on each machine is held in intermediate structures. During this step, the operation can still be canceled and rollbacked.

The engine commits the transfers (block 506). Finally, the frame is rebuilt using the received data in the intermediate structures and sent data is removed. By the end of this step, the frame is fully rebalanced. Thereafter, operation ends (block 507).

### Defining Cardinality Goals

The first step of rebalancing is the computation of the target distribution. Because rebalancing is based on the number of chunks, to leverage the internal segmented column-based design of the frames, the target distribution specifies the number of chunks each machine must have by the end of the operation. For simplicity, both full and non-full chunks are treated similarly. As part of the input, each machine is assigned a weight that corresponds to the volume of data it is intended to hold, ensuring proportionality between machine capacity and data allocation.

By the end of this stage, the target chunks distribution is generated and will have the same total number of chunks as the current chunks distribution. This may not hold after rebalancing (i.e., the final chunks distribution may be different to the target chunks distribution) because non full chunks may merge and result in fewer chunks—to keep the frame packed with each machine having, at most, one non-full chunk.

Target chunks distribution is dependent on the provided machines weights. It follows a best-effort approach where on each machine:
1. Aggregate the per-machine number of local chunks.
2. Assign a single chunk to every machine with a non-zero weight, starting from machine with ID=0 and stop once no chunks are left. This is necessary because directly applying CHUNKS_NUM * machine_weights [IDX] could yield a decimal value less than 1. In such cases, although the machine weight is positive, the machine with ID =IDX would receive no chunks. If a machine has a zero weight, it will not have any chunks assigned to it. Conversely, a machine with a positive weight will be allocated a number of chunks that is approximately proportional to its weight.
3. Keep assigning the remaining chunks until none are left, i.e., the sum of chunks in the target is equal to the sum of chunks currently held by the frame.

Machines weights are provided as an argument for rebalancing to ensure on-demand distribution. In one embodiment, weights are computed solely using memory resources on each machine. In alternative embodiments, weights can also be built depending on the computational power or a variant of both memory resources and computational power. Moreover, this approach can be easily leveraged in a cloud environment to partition data so it is held in the same region for improved messaging, or to improve tenants allocation depending on previous usage to optimize user experience.

### Examining the Need for Rebalancing

The second step of rebalancing consists of evaluating if the difference between current and target chunks distribution necessitates performing the operation. This step is required to verify the need for rebalancing since the operation may be expensive, depending on the size of the frame, hogging the session for the duration of the operation making it unavailable to the user. In an example use case, the engine keeps track of versioning of each frame within the session. Rebalancing occurs when a new data structure is created to match the current session version, and then whenever a change occurs in the elastic cluster (i.e., adding/removing machines) to match the new session version. As an example, if a machine has a weight of 0, then it must not have any chunks, as it is likely that it is to be removed from the cluster. Hence, all data must be transferred from the machine with the zero weight, even if this step would otherwise skip the rebalancing.

However, verification can be enabled using different approaches such as:
Comparing current and target chunks distribution with or without an error-margin. While the latter may seem similar to our approach, it may require more calls to the rebalancing operation since the final chunks distribution may be different to the target chunks distribution, it will however eventually converge.
The difference between median and average difference between current and target chunks distributions. To limit variance of differences between machines eventually making it fully balanced.
Root mean squared error, or any similar cost function with an acceptable margin.

### Transfers Preparation

The third step and the core of the rebalancing operation is the preparation of the transfers that must be applied to attend the target chunks distribution starting from the current distribution. It is at this stage that the unordered and the order-preserving rebalancing diverge. As mentioned above, transfers here are complete descriptions of a data movement that must be conducted in the subsequent steps.

While the two approaches differ in how the transfers are generated, they nonetheless share the same structure for the transfer, with the following attributes:
receiver_ID: the identifier designating the destination machine to which the data is required to be transmitted. This value is also used to deduce whether data is being transferred to a previous or a subsequent machine.
sender_ID: identifier of the sender machine from which the data is to be transferred.
local_chunk_ID: the index of the chunk to be sent in the local array of chunks owned by the sender machine.
row_offset: this attribute represents the number of rows that must be skipped on the chunk with local_chunk_ID before starting to copy the values from the next num_rows in the frame. This is kept to the value of 0 in case of unordered rebalancing and only used in the order-preserving flavor. For a valid transfer, the value of row_offset must be less than the capacity of a chunk in the frame.
num_rows: the number of rows that must be moved from the sender machine to the destination machine with ID=receiver_ID. For a valid transfer, its value must be greater than 0 and less than or equal to the capacity of a chunk in the frame. In the case where row_offset is positive, and row_offset+num_rows is greater than the number of rows in the chunk with an index equal to local_chunk_ID, the transfer will apply a best effort approach to complete the needed rows from the next chunk with ID=local_chunk_ID+1. In case of the unordered rebalancing, the default value is kept, which is the capacity of a chunk in the frame.
transfer_index: in case of order-preserving rebalancing, the order of the chunk must be preserved to deduce the order of the rows it is holding. Since the data movement is done in a parallel manner asynchronously, it is required to send the order of the chunk with the data values. Later, this attribute is used with the machine ID that sent the data to find the overall order on the receiving machine.
   As mentioned above, the generation of transfers differs depending on whether the order of rows is preserved or not, we distinguish both approaches in the following subsections.

### Unordered Rebalancing

Unordered rebalancing disregards the initial order of rows in a frame and, thus, it can tolerate any data movement in the cluster. The goal is to balance the frame according to the input per-machine weights while minimizing the overall number of transfers. To achieve this, the graph engine detects the machines with surplus, i.e., where the current number of chunks is strictly larger than the target number of chunks, and moves them directly to machines with a deficit, i.e., where the current number of chunks is strictly less than the target number of chunks. Moreover, the graph engine tries to avoid the need to repacking the frame, to make sure it only carries at most a single non-full chunk on each machine, by prioritizing the transfer of full chunks.

Generating transfers occurs simultaneously on all machines, and the process is as follows—for each machine with excess:
1. Find a machine with lack starting from receiver_ID=0.
2. Once a receiver machine is found, send min (surplus, deficit): generate enough transfers to cover the minimum between the number of chunks of surplus in the sender machine and the number of chunks of deficit in the receiver machine.
3. Update the new chunks count by subtracting the number of transfers generated from the number of chunks in the sender machine and add it to the number of chunks in the receiver machine.
4. Continue, until current machine has no chunks in surplus.

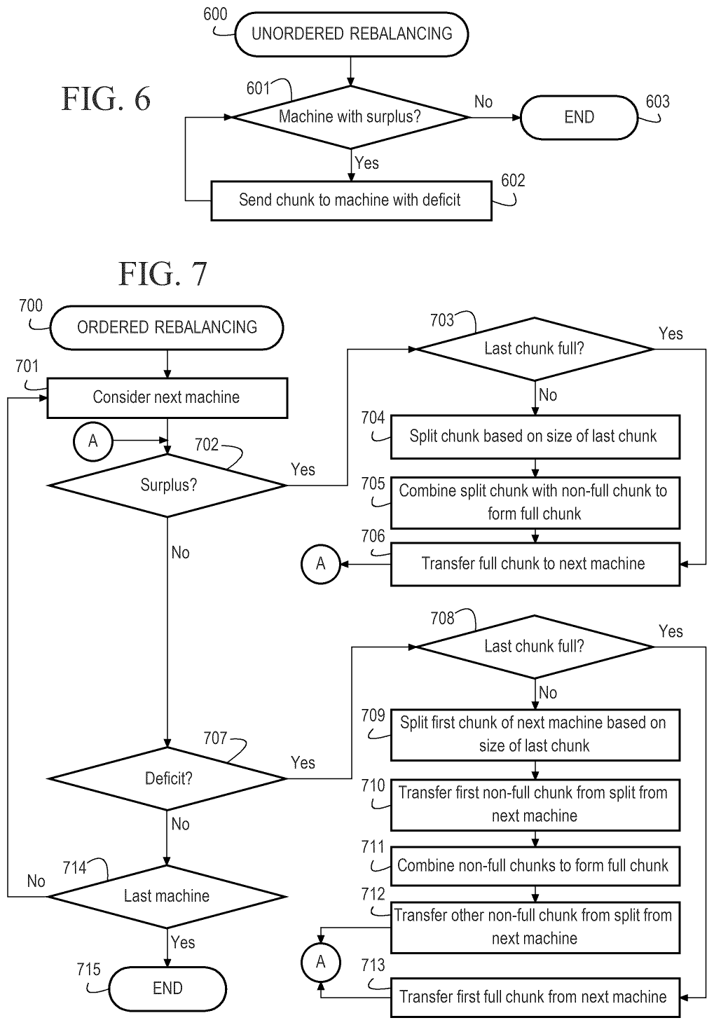

FIG. 6 is a flowchart illustrating operation of a distributed asynchronous graph engine for unordered result set rebalancing in accordance with an embodiment. Operation begins for unordered rebalancing (block 600), and the graph engine determines whether there is a machine with a surplus of chunks, i.e., a current number of chunks that is greater than the target number of chunks for that machine (block 601). If there is a machine with a surplus (block 601: Yes), then the engine sends a full chunk to a machine with a deficit of chunks, i.e., a current number of chunks that is less than the target number of chunks for that machine (block 602). In one embodiment, the engine may cause the machine with the surplus to send a single full chunk to the machine with the deficit. In an alternative embodiment, as described above, the engine may determine a minimum of the surplus number and the deficit number of chunks (min (surplus, deficit)) and cause the machine with the surplus to send that number of full chunks to the machine with the deficit.

Operation returns to block 601 to determine if there is a machine with a surplus of chunks. This process repeats until the graph engine determines there is no machine with a surplus (block 601: No), at which point operation ends (block 603). Even if there is a machine with a deficit, no chunk can be transferred if there is no machine with a surplus. Similarly, if there is a machine with a surplus in block 601 but no machine with a deficit in block 602, then the graph engine would not cause a chunk to be transferred, because this would result in an endless loop of a chunk being transferred back and forth between two machines.

### Order-Preserving Rebalancing

Generating transfers in this mode of rebalancing is trickier, because it is important to not only minimize the number of transfers between machines but also to keep the same order of rows in the frame. To minimize the number of transfers, an embodiment opts to send each point of data directly to its final destination. This can only be achieved by having a detailed overall understanding of the distribution. Thus, every machine generates all the transfers that are to be made locally but would only apply those in which it is a sender.

The following are the main constraints that must be considered:
When sending to a previous machine, the destination machine may contain a non-full chunk that must be padded before sending full chunks, because all received chunks from a subsequent machine must be appended to the tail of the chunks array.
When sending to a subsequent machine, it is necessary to send full chunks only (i.e., the number of rows sent is the same as the capacity of a chunk in the frame), because the received chunks will be pushed to the front of the chunks array in the receiving machine.
Multiple machines may send to the same destination; therefore, for each machine, the machine must know if a previous or a subsequent machine has transferred data, which may change the number of rows in the non-full chunk of the receiver machine.
If the chunks stay on the same machine, they should not be split/moved.

To deal with the constraints mentioned above, a set of rules is established:
1. When sending to a previous machine, a machine first sends enough rows to pad the non-full chunk in the receiver machine if any. To find the number of rows in this case, the graph engine calculates the sum of the number of rows in the non-full chunks from all previous machines that are sent to the same destination starting from the receiver machine.
2. When sending to a subsequent machine with the current machine being the first sender to that destination, the machine must skip enough rows such that the number of rows in the remaining non-full chunk sent plus the sum of the number of rows in the non-full chunks from the subsequent machines prior to the destination machine that are to be sent to the destination is a multiplier of the capacity of a chunk in the frame.

Note that the second constraint would require, in the case where the sender machine has a weight 0, such as when the machine is to be removed from the cluster, to have at least one subsequent machine with a positive weight to hold the skipped rows. In the illustrative embodiment, this is always true, because the leader machine (i.e., ID=0) always has a weight greater than 0.

The generation of order-preserving transfers can be described as follows:
1. Initialize sender_ID and receiver_ID to 0.
2. While receiver machine still does not have enough chunks:
   a. Initialize row_offset and transfer_index to 0.
   b. If sender_ID is greater than receiver_ID, i.e., sending to a previous machine:
      i. Compute the sum of number of rows from all the previously generated transfers to receiver_ID and find the rest of the division by the capacity of a chunk in the frame. This result is the new number of rows in the non-full chunk in sender_ID. Send a first chunk with num_rows =CHUNK_ROWS_CAPACITY−non_full_chunk_row_num to pad the non-full chunk. Update row_offset to the number of rows sent num_rows and keep the same local_chunk_ID. Increment transfer_index.
      ii. Keep sending full chunks with num_rows=CHUNKS_ROWS_CAPACITY until no more chunks are left on the sender machine, or no more chunks are needed in the receiver machine.
      iii. If a non-full chunk is left in the head of the sender machine, it is to be transferred to the receiver machine to become the new non-full chunk, which is essential to apply the constraint of having at most a single non-full chunk at the tail of each machine.
   c. Else, i.e., when sending to self or a subsequent machine:
      i. First, we compute the number of rows to be skipped by finding the rest of the division by the CHUNK_ROWS_CAPACITY of the sum of the rows in machines subsequent to the sender and prior to the receiver such as the sum of rows is enough to fill chunks to cover the needs of the receiver machine. If rows are found to be skipped, they are first sent to the first machine where ID<=sender_ID with a positive weight starting from the sender machine with a transfer_index=target chunks distribution [ID]+1 to be appended to the tail of the chunk array in the next steps of rebalancing, next row_offset is set to the number of rows skipped.
      ii. If the current sender is not the first sender to the receiver machine, the transfer is treated as if the sender machine is sending to a previous machine.
      iii. Keep sending full chunks with num_rows=CHUNKS_ROWS_CAPACITY until no more chunks are left on the sender machine, or no more chunks are needed in the receiver machine. If a non-full chunk is left in the head of the sender machine, it is to be transferred to the receiver machine to become the new non-full chunk on the receiver machine.
   d. If no more chunks are left on the sender machine, then increment sender_ID, else if no more chunks are needed in the receiver machine, then increment receiver_ID.

FIG. 7 is a flowchart illustrating operation of a distributed asynchronous graph engine for order-preserving result set rebalancing in accordance with an embodiment. Operation begins for ordered rebalancing (block 700), and the graph engine considers the first machine (block 701). The graph engine determines whether the current machine has a surplus number of chunks (block 702). If the current machine has a surplus (block 702: Yes), then the engine determines whether the last chunk of the current machine is a full chunk (block 703). If the last chunk is a non-full chunk (block 703: No), then the current machine splits the chunk previous to the last chunk based on a number of rows in the last non-full chunk (block 704). The current machine combines rows from the split chunk with the non-full chunk to form a full chunk (block 705). Thereafter, or if the last chunk in the current machine is full (block 703: Yes), the current machine transfers the now full chunk to the next machine (block 706). Then, operation returns to block 702 to determine if the current machine has a surplus. This process may be repeated until the current machine no longer has a surplus. In alternative embodiment, blocks 704-706 may be repeated to form a number of full chunks that can be transferred to the next machine such that the current machine will no longer have a surplus.

If the current machine does not have a surplus number of chunks (block 702: No), then the graph engine determines whether the current machine has a deficit number of chunks (block 707). If the current machine has a deficit (block 707: Yes), then the engine determines whether the last chunk of the chunks array in the current machine is a full chunk (block 708). If the last chunk is a non-full chunk (block 708: No), then the engine causes the first chunk of the next machine to be split based on a number of rows in the last non-full chunk of the current machine (block 709). The graph engine causes the first non-full chunk, i.e., the rows from the split chunk that follow the last non-full chunk of the previous machine, to be transferred from the next machine to the current machine (block 710). The current machine then combines the non-full chunk with the transferred rows to form a full chunk (block 711). The graph engine causes the other non-full chunk, i.e., the remaining rows from the split chunk, to be transferred from the next machine to the current machine (block 712). Thereafter, operation returns to block 702 to determine if the current machine has a surplus. If the last chunk is a full chunk (block 708: Yes), then the graph engine causes the first full chunk in the chunks array of the next machine to be transferred to the current machine (block 713). Thereafter, operation returns to block 702 to determine if the current machine has a surplus. This process may be repeated until the current machine no longer has a surplus or a deficit. In alternative embodiment, blocks 709-712 or block 713 may be repeated to transfer rows from the next machine to the current machine and form full chunks on the current machine such that only the last chunk is a non-full chunk, thus resulting in the current machine no longer having a deficit.

If the current machine does not have a deficit (block 707: No), then the graph engine determines whether the current machine is the last machine in the distributed graph processing system (block 714). If the current machine is the last machine (block 714: Yes), then operation ends (block 715). If the current machine is not the last machine (block 714: No), then operation returns to block 701 to consider the next machine. The process then repeats until the last machine is reached without a machine having a surplus or a deficit.

Note that if the last machine has a surplus, then there is no next machine to which chunks can be transferred. Therefore, blocks 704-706 can only be performed if there is a next machine. Similarly, if the last machine has a deficit, then there is no next machine from which to transfer rows or chunks. Therefore, blocks 709-712 or block 713 can only be performed if there is a next machine. However, if only the last machine has a surplus or a deficit, then the ordered rebalancing has come as close as possible to the target distribution.

### Reservation-First Protocol

Once the transfers are generated, it is possible to estimate the needed memory size on each machine to hold the received chunks. Estimation is preferred at this stage because calculating the exact value can be expensive when the frame is holding a data type of dynamic size, such as strings.

The main goal of this stage is to act as a preventive measure. The graph engine must make sure that all machines are able to hold the sent chunks before performing the rebalancing, which can be expensive and canceled in case of a failure to acquire memory in any machine. Because the order is necessary, the final chunk array cannot be built with gaps in the data.

This is not an easy constraint, because in the case where all of the data is to be transferred across the cluster, the same amount of memory as the frame is currently using will be needed. To solve this issue of rebalancing with limited memory, the concept of gradual rebalancing is introduced, as will be discussed below.

### Transfers Execution

This stage consists of moving the data based on the transfers previously generated. The received data on each machine is held in intermediate structures before building the final result, and thus the rebalancing is still cancelable up to this point.

When performing a transfer two possible cases can occur:
1. The transfer consists of moving the full chunk, i.e., row_offset=0 and num_rows =CHUNK_ROWS_CAPACITY, as all transfers in the unordered mode, or row_offset +num_rows <=chunks [local_chunk_ID]. get_num_rows ( ), which can occur in some cases of the order-preserving rebalancing such as sending leftover rows, skipped rows and padding rows.
2. The transfer consists of moving a chunk formed by the tail rows from the chunk with ID =local_chunk_ID and the head rows of the following chunk to complete the transfer needed rows. This only occurs in case of order-preserving rebalancing.

Both implementations are designed to leverage all design characteristics of the frame. The data is moved in a column-oriented manner, which sets the need for at most two calls of memcpy for each column. When performing transfers for unordered rebalancing, columns are copied in a single call. In case of dynamic data types such as strings, the copying is done row by row for each column.

For the intermediate structures holding the received chunks on each machine, they can either be implemented as an array in case of the unordered rebalancing, or a 2D-array in case of the order-preserving one, such as the first level is the sender_ID and the second level is the transfer_index, because all chunks from a previous machine will end up in the front and all chunks from subsequent machines will end up in the back. In both cases, the intermediate structures can be allocated before performing the transfers, to avoid writing concurrency for a better performance, such as each thread can directly access the required index with no locking mechanism.

In case where sender_ID=receiver_ID, we simply copy the pointers to the chunk with local_chunk_ID to the intermediate structures. In such case, it is guaranteed that no chunk splitting is required, because all kept chunks are designed to have a row_offset=0 and num_rows=chunks [local_chunk_ID].get_num_rows ( ).

### Transfers Committing

Finally, the last step of rebalancing is to build the final result, by assembling the received chunks with the kept chunks, if any. At this stage cancelling is no longer possible.

First, transfers committing starts by destroying all sent chunks. Any chunk ID found in transfers to previous machines are to be removed since the solution makes sure that no non-full chunk is kept in the head of the chunks array. In case of transfers to subsequent machines, only the first transfer with sender_ID==ID and receiver_ID>sender_ID is required to get accessed, all chunks with ID greater than local_chunk_ID are removed, and for the latter, all leftover rows after the first row_offset rows are destroyed.

Next, the solution continues by assembling the chunks residing in the intermediate structures, starting from sender_ID=0 and so on. In case of unordered rebalancing, this consists of removing the sent chunks from the head of the chunks array and appending the received chunks to the back, finally calling the packing method to make sure that at most a single non-full chunk resides on each machine in the cluster.

For the order-preserving rebalancing, in case where the received chunk is non-full, the solution concatenates it with the following chunk. This can be done by directly copying all rows from the following chunk to the current one, because their size should be complementary up to the capacity of a full chunk in the frame. Each built or received chunk is appended to the back of the chunks array until the whole intermediate structure is probed.

Once this step is completed, the frame is rebalanced. This does not guarantee that the final chunks distribution matches the target but converges to the intended distribution.

### Gradual Rebalancing

During the execution of the rebalancing operation, the system is inaccessible to the user. This undesirable behavior is particularly problematic as rebalancing may be initiated by the system itself to enhance partitioning. Additionally, the system may encounter constraints such as limited available memory, preventing it from rebalancing the entire frame in a single operation.

To address these issues, an embodiment proposes a gradual rebalancing approach, in which at each call of the rebalancing operation, the system limits the maximum number of chunks to be sent or received, to limit the execution time and improve availability to the user. Moreover, gradual rebalancing is also limited by the available memory on each machine to dictate the maximum number of chunks it is possible to receive and, thus, allows the system to better tolerate rebalancing the frame with limited memory.

However, with each call, the operation only converges toward the target chunks distribution. This may result in slower overall execution compared to performing it in a single call.

To implement such a feature, the embodiment opts for a simplistic implementation in which an algorithm is embedded in the first step that alters the provided weights to accommodate the constraints. The rest of the execution is kept untouched.

A new parameter is introduced to cap the maximum weight change each machine can induce. This threshold can be computed by using a predefined maximum data size each machine can send/receive and an estimation over the size of a single chunk. The algorithm uses a heuristic approach designed to transition the current data distribution towards a target distribution, which is based on the provided machine weights, while respecting the specified threshold constraint. First, it calculates the number of possible changes for each machine (negative when the machines have an excess and positive otherwise), which is limited by the provided threshold (abs(max_possible_changes[ID]<=threshold). Then, it identifies the indices of the maximum and minimum possible changes used to adjust the max_possible_changes array by subtracting their absolute minimum to the index of maximum possible changes and adding it to the index with minimum possible changes in the current distribution array. Finally, the algorithm returns the new distribution array as the new rebalancing target.

For example, suppose the following current distribution being (10, 20, 40, 30) and the target being (25, 25, 25, 25) given a threshold=5. First we compute the maximum possible changes which results in the following: (5, 5, −5, −5), the algorithm then identifies the indices with the most excess (min)/lacking (max) (0, 2), applies their minimum absolute to the current distribution array resulting in (15, 20, 35, 30), and updates the maximum possible changes to reflect the applied changes (0, 5, 0, −5). The algorithm continues in a similar manner, which results in the current distribution becoming (15, 25, 35, 25). Thus, the first rebalancing iteration would have a target distribution (15, 25, 35, 25) instead of (25, 25, 25, 25). The second iteration of rebalancing would start at (15, 25, 35, 25) and target (20, 25, 30, 25). Finally, in the last iteration the rebalancing will target the original target distribution (25, 25, 25, 25).

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

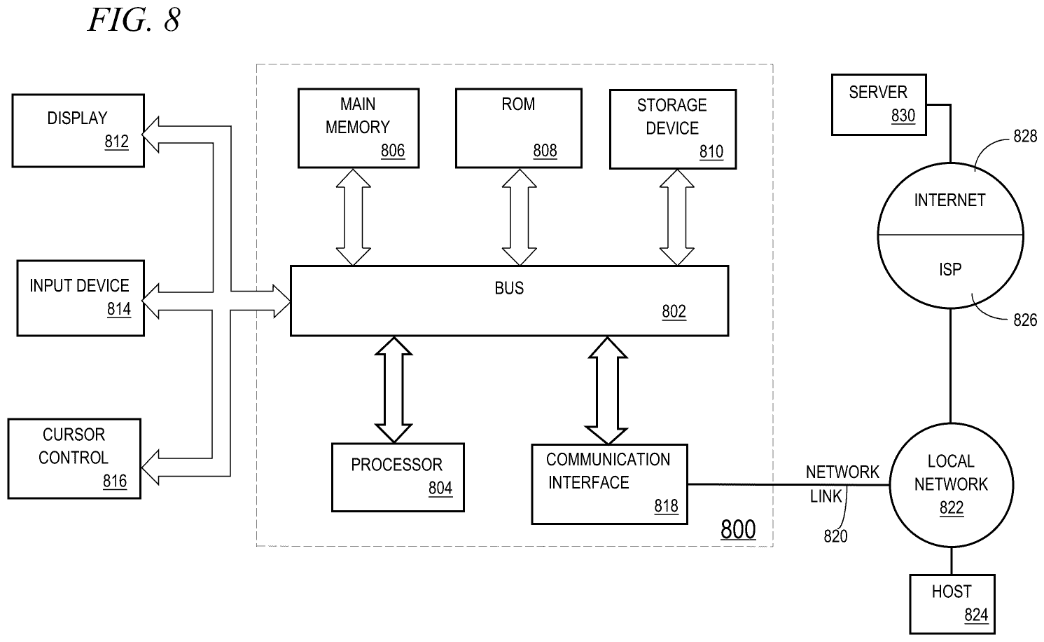

For example, FIG. 8 is a block diagram that illustrates a computer system 800 upon which aspects of the illustrative embodiments may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Overview

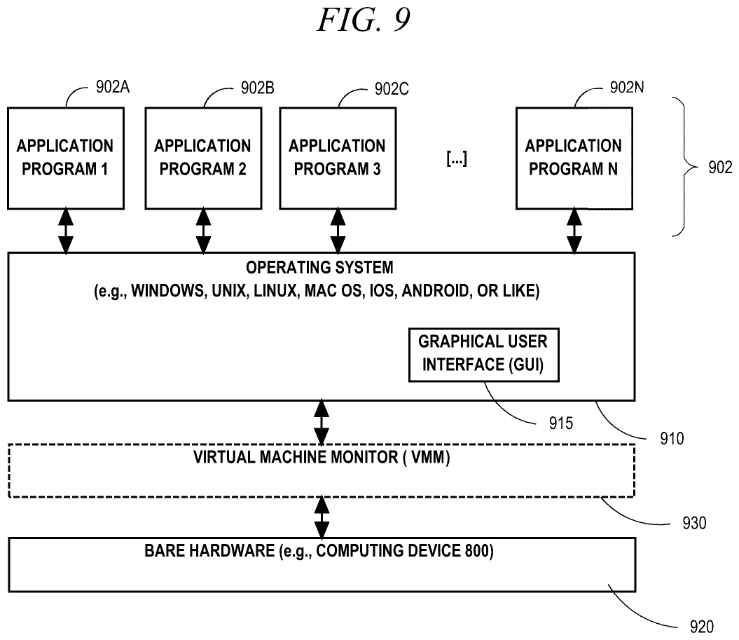

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
performing a rebalancing operation to rebalance a result set produced by one or more database operations performed by a cluster of machines in a distributed system, wherein:
the result set comprises a result set data structure in a tabular format comprising a plurality of rows,
the result set is segmented into a set of chunks distributed across the cluster of machines,
each chunk of the set of chunks contains a subset of the plurality of rows,
each machine in the cluster of machines contains zero or more chunks of the set of chunks in an initial distribution of the set of chunks across the cluster of machines, and
performing the rebalancing operation comprises:
determining a target distribution of the set of chunks across the cluster of machines;
identifying a first subset of one or more machines within the cluster of machines having a surplus of one or more chunks based on the target distribution;
identifying a second subset of one or more machine within the cluster of machines having a deficit of one or more chunks based on the target distribution; and
transferring one or more chunks from the first subset of one or more machines to the second subset of one or more machines to rebalance the distribution of the set of chunks across the cluster of machines,
wherein the method is performed by one or more computing devices.

2. (canceled)

3. The method of claim 1, wherein:
the one or more operations comprise a graph pattern matching operation, an aggregation operation, and a sorting operation,
the result set is an intermediate result set produced after the graph pattern matching operation, prior to the aggregation and sorting operations, and prior to the result set being accessible by a user, and
the rebalancing operation is an unordered rebalancing operation.

4. The method of claim 3, wherein the unordered rebalancing operation comprises:
transferring a number of chunks from a first machine within the first subset of one or more machines to a second machine within the second subset of one or more machines, wherein the number of chunks is equal to a minimum of a surplus number of chunks in the first machine and a deficit number of chunks in the second machine;
updating a distribution of the set of chunks across the cluster of machines to form an updated distribution by subtracting the number of chunks from the first machine and adding the number of chunks to the second machine; and
repeating transferring the number of chunks and updating the distribution of the set of chunks across the cluster of machines until the first machine does not have a surplus of chunks.

5. The method of claim 1, wherein:
the one or more operations comprise a graph pattern matching operation, an aggregation operation, and a sorting operation,
the result set is produced after the aggregation and sorting operations or the result is accessible by a user, and
the rebalancing operation is an ordered rebalancing operation such that an order of results after the rebalancing operation is the same as an order of results prior to the rebalancing operation.

6. The method of claim 5, wherein:
a given machine within the cluster of machines has a surplus of one or more chunks,
a previous machine within the cluster of machines has a deficit of one or more chunks,
the previous machine has a last non-full chunk, and
the ordered rebalancing operation comprises:
dividing a first chunk of the given machine into a first non-full chunk containing a number of rows required to pad the last non-full chunk to form a full chunk and a second non-full chunk;
transferring the first non-full chunk from the given machine to the previous machine;
appending the last non-full chunk and the first non-full chunk in the previous machine to form a full chunk; and
transferring the second non-full chunk from the given machine to the previous machine.

7. The method of claim 5, wherein:
a given machine within the cluster of machines has a surplus of one or more chunks,
the given machine has a last non-full chunk, and
the ordered rebalancing operation comprises:
dividing a penultimate chunk of the given machine into a first non-full chunk and a second non-full chunk containing a number of rows required to pad the last non-full chunk to form a full chunk;
appending the second non-full chunk and the last non-full chunk in the given machine to form a last full chunk; and
transferring the last full chunk from the given machine to the next machine.

8. The method of claim 1, wherein:
the target distribution of the set of chunks across the cluster of machines is determined based on a set of machine weights,
each machine weight within the set of machine weights corresponds to a volume of data its respective machine is intended to hold.

9. The method of claim 8, wherein a given machine in the cluster of machines has a weight of zero.

10. The method of claim 1, wherein transferring the one or more chunks from the first subset of one or more machines to the second subset of one or more machines is performed in response to a difference between the initial distribution and the target distribution being outside an error-margin.

11. The method of claim 1, wherein:
the rebalancing operation comprises a gradual rebalancing operation, and
determining the target distribution comprises limiting a difference in number of chunks for a given machine in the cluster of machines to a threshold.

12. One or more non-transitory computer-readable media storing instructions which, when executed by one or more processors, cause:
performing a rebalancing operation to rebalance a result set produced by one or more database operations performed by a cluster of machines in a distributed system, wherein:
the result set comprises a result set data structure in a tabular format comprising a plurality of rows,
the result set is segmented into a set of chunks distributed across the cluster of machines,
each chunk of the set of chunks contains a subset of the plurality of rows,
each machine in the cluster of machines contains zero or more chunks of the set of chunks in an initial distribution of the set of chunks across the cluster of machines, and
performing the rebalancing operation comprises:
determining a target distribution of the set of chunks across the cluster of machines;
identifying a first subset of one or more machines within the cluster of machines having a surplus of one or more chunks based on the target distribution;
identifying a second subset of one or more machine within the cluster of machines having a deficit of one or more chunks based on the target distribution; and
transferring one or more chunks from the first subset of one or more machines to the second subset of one or more machines to rebalance the distribution of the set of chunks across the cluster of machines.

13. (canceled)

14. The one or more non-transitory computer-readable media of claim 12, wherein:
the one or more operations comprise a graph pattern matching operation, an aggregation operation, and a sorting operation,
the result set is an intermediate result set produced after the graph pattern matching operation, prior to the aggregation and sorting operations, and prior to the result set being accessible by a user, and
the rebalancing operation is an unordered rebalancing operation.

15. The one or more non-transitory computer-readable media of claim 14, wherein the unordered rebalancing operation comprises:
transferring a number of chunks from a first machine within the first subset of one or more machines to a second machine within the second subset of one or more machines, wherein the number of chunks is equal to a minimum of a surplus number of chunks in the first machine and a deficit number of chunks in the second machine;
updating a distribution of the set of chunks across the cluster of machines to form an updated distribution by subtracting the number of chunks from the first machine and adding the number of chunks to the second machine; and
repeating transferring the number of chunks and updating the distribution of the set of chunks across the cluster of machines until the first machine does not have a surplus of chunks.

16. The one or more non-transitory computer-readable media of claim 12, wherein:
the one or more operations comprise a graph pattern matching operation, an aggregation operation, and a sorting operation,
the result set is produced after the aggregation and sorting operations or the result is accessible by a user, and
the rebalancing operation is an ordered rebalancing operation such that an order of results after the rebalancing operation is the same as an order of results prior to the rebalancing operation.

17. The one or more non-transitory computer-readable media of claim 16, wherein:
a given machine within the cluster of machines has a surplus of one or more chunks,
a previous machine within the cluster of machines has a deficit of one or more chunks,
the previous machine has a last non-full chunk, and
the ordered rebalancing operation comprises:
dividing a first chunk of the given machine into a first non-full chunk containing a number of rows required to pad the last non-full chunk to form a full chunk and a second non-full chunk;
transferring the first non-full chunk from the given machine to the previous machine;
appending the last non-full chunk and the first non-full chunk in the previous machine to form a full chunk; and
transferring the second non-full chunk from the given machine to the previous machine.

18. The one or more non-transitory computer-readable media of claim 16, wherein:
a given machine within the cluster of machines has a surplus of one or more chunks,
the given machine has a last non-full chunk, and
the ordered rebalancing operation comprises:
dividing a penultimate chunk of the given machine into a first non-full chunk and a second non-full chunk containing a number of rows required to pad the last non-full chunk to form a full chunk;
appending the second non-full chunk and the last non-full chunk in the given machine to form a last full chunk; and
transferring the last full chunk from the given machine to the next machine.

19. The one or more non-transitory computer-readable media of claim 12, wherein:
the target distribution of the set of chunks across the cluster of machines is determined based on a set of machine weights,
each machine weight within the set of machine weights corresponds to a volume of data its respective machine is intended to hold.

20. The one or more non-transitory computer-readable media of claim 12, wherein:
the rebalancing operation comprises a gradual rebalancing operation, and
determining the target distribution comprises limiting a difference in number of chunks for a given machine in the cluster of machines to a threshold.

21. The method of claim 1, further comprising performing one or more operations on the rebalanced result set using the cluster of machines.

22. The method of claim 1, wherein transferring the one or more chunks from the first subset of one or more machines to the second subset of one or more machines comprises performing multiple transfers from the first subset of one or more machines to the second subset of one or more machines simultaneously.
